(19) United States
(12) Patent Application Publication
(10) Pub. No.: US 2013/0132752 A1
(43) Pub. Date: May 23, 2013

(54) POWER SUPPLIER OF COMPUTER SYSTEM AND POWER SUPPLY METHOD THEREOF

(71) Applicant: Chia-Hsiang Chen, Taipei (TW)

(72) Inventor: Chia-Hsiang Chen, Taipei (TW)

(73) Assignee: INVENTEC CORPORATION, Taipei (TW)

(21) Appl. No.: 13/348,141

(22) Filed: Jan. 11, 2012

(30) Foreign Application Priority Data
Nov. 23, 2011 (TW) 100142999

(51) Int. Cl. G06F 1/32

(52) U.S. Cl. 713/323

(57) ABSTRACT

A power supplier of a computer system and a power supply method thereof are described. The power supply method includes the following steps, receiving a validation code when a computer system enters a working mode from a standby mode; determining whether the validation code is in accordance with a preset code; If the validation code is in accordance with the preset code, executing a power sequence control so that the power supplier generates a plurality of working voltages required by the computer system; and if the validation code is not in accordance with the preset code, powering off the computer system or keeping the computer system in the standby mode.

### CROSS-REFERENCE TO RELATED APPLICATIONS

This non-provisional application claims priority under 35 U.S.C. §119(a) on Patent Application No(s). 100142999 filed in Taiwan, R.O.C. on Nov. 23, 2011, the entire contents of which are hereby incorporated by reference.

### BACKGROUND

1. Technical Field

The present disclosure relates to a power supplier, and more particular to a power supplier of a computer system and a power supply method thereof.

2. Related Art

Generally, voltage supply from a power supplier can be classified into two kinds of voltages, i.e., an AUX power and a MAIN power. The AUX power is a standby power used by a computer system in a standby mode, and the MAIN power is a main voltage source required by the operation of the computer system. By differentiating these two kinds of voltage, when the computer system is in the standby mode, the reactive power waste resulting from meaningless electrical power consumption may be prevented.

After the standby power is used, the computer system enters the standby state. Then, when the computer system detects a booting request or a re-login request (usually shown as the power-on mode S0-S5), a wake-up trigger is performed on a modulation voltage circuit of each module in the computer system by a power supply sequence and a judging management system in the computer system so as to provide each element with its required power and thus performing the boot process for the computer.

A common power management device determines whether to enter the next state based on the voltage inputs and outputs of voltage regular down (VRD) modules. Specifically, the common power management device gives an input to a first VRD module and waits for a power good signal sent back from the first VRD module. As soon as receiving the power good signal, the common power management device enters the next state. That is to say, when a user presses a power-on button to start the computer system or operates a mouse and a keyboard to wake up the computer system, the power supplier performs a power sequence control, so as to provide the voltage required by the computer system, thereby enabling the computer system to finish the boot process. However, the above mentioned power supply manner of the power supplier does not set any authentication mechanism to determine whether the power supplier performs power supply. Therefore, the security for the power supply of the power supplier is still to be improved.

### SUMMARY

The present disclosure provides a power supply method of a power supplier, which comprises the following steps: receiving a validation code when a computer system enters a working mode from a standby mode; determining whether the validation code is in accordance with a preset code; if the validation code is in accordance with the preset code, executing a power sequence control, so that the power supplier generates a plurality of working voltages required by the computer system; and if the validation code is not in accordance with the preset code, powering off the computer system or keeping the computer system in the standby mode.

The present disclosure further provides a power supplier of a computer system, which comprises a power supply module and a control module. The power supply module is used to provide a plurality of standby voltages and a plurality of working voltages. The control module is coupled to the power supply module, and used to receive a validation code and a preset code, so as to determine whether to control the power supply module to execute a power sequence control according to the validation code and the preset code to convert the standby voltages to the working voltages. When the computer system enters a working mode from a standby mode and the control module determines that the validation code accords with the preset code, the control module controls the power supply module to execute the power sequence control, so that the power supply module provides the working voltages to the computer system, and when the computer system enters the working mode from the standby mode and the control module determines that the validation code is not in accordance with the preset code, the control module controls the power supply mode not to provide the working voltages to the computer system or to continue providing the standby voltages to the computer system.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of the computer system according to the present disclosure;

FIG. 2 is a flow-chart of the power supply method of the power supplier according to the present disclosure; and

FIG. 3 is a flowchart of the power supply method of the power supplier according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

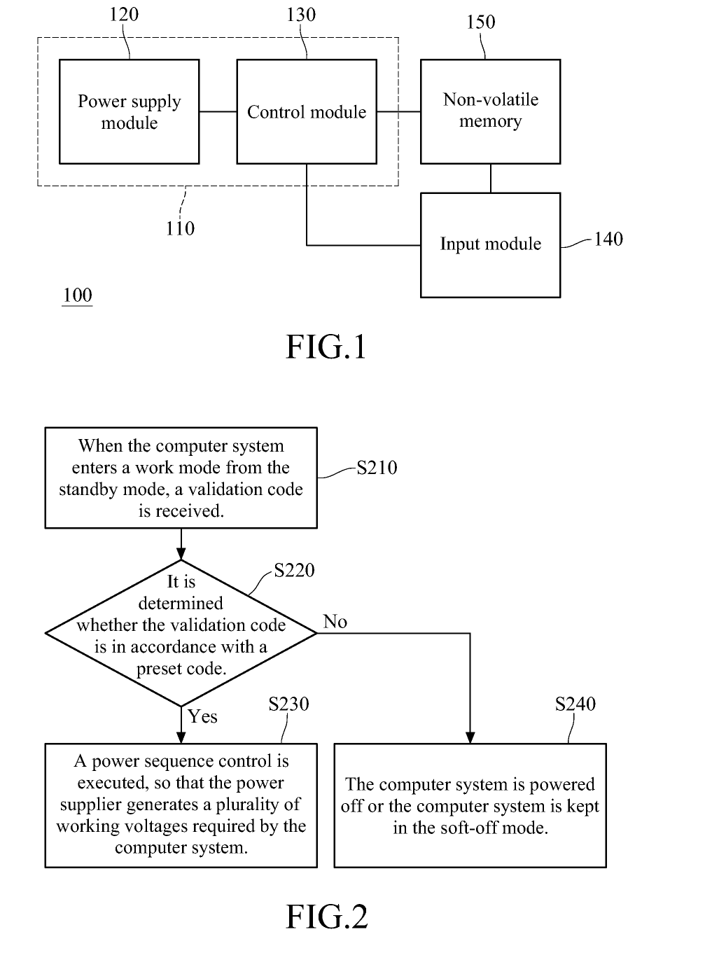

FIG. 1 is a block diagram for a part of elements of a computer system according to the present disclosure. Referring to FIG. 1, in this embodiment, it is assumed that the computer system 100 is in a standby mode (for example, an idle mode or a pre-power-on mode). The computer system 100 comprises a power supplier 110 which comprises a power supply module 120 and a control module 130. The power supply module 120 is used to provide a plurality of standby voltages and a plurality of working voltages. The standby voltage is a voltage required by the computer system 100 during the standby mode, and the working voltage is a voltage required by the computer system 100 in normal operation. Further, the standby voltages are respectively 1.1 V, 1.25 V, 1.5 V, 3.3 V, and etc., and the working voltages are respectively 1.1 V, 1.5 V, 3.3 V, 5 V, 6.5 V, and etc.

The control module 130 is coupled to the power supply module 120 and is used to receive a validation code and a preset code to determine whether to control the power supply module 120 to execute a power sequence control according to the validation code and the preset code. As a result, the power supply module 120 provides the working voltages instead of the standby voltages to the computer system 100, so as to enable the computer system to enter a normal working mode. The control module 130 may be a board management controller (BMC).

In this embodiment, when detecting that the computer system 100 enters the working mode from the standby mode and determining that the validation code is in accordance with the preset code, the control module 130 controls the power supply module 120 to execute the power sequence control to sequentially provide a plurality of working voltages required by the computer system 100. In another aspect, when detecting that the computer system 100 enters the working mode from the standby mode and determining that the validation code is not in accordance with the preset code, the control module 130, for example, generates a control signal to control the computer system 100 to be powered off or control the power supply module 120 to continue providing the standby voltages for the standby mode of the computer system. In this manner, the security for power supply of the computer system 100 may be effectively improved.

In addition, the computer system 100 further comprises an input module 140 for providing the preset code. In this embodiment, the input module 140 may be a dip switch which for example has an 8-bit output. That is, the dip switch may provide a preset code from “00000000” to “11111111”, and a computer manager may adjust the position of the dip switch to generate the required preset code, for example, “01010110”, thereby protecting the power supply of the computer system 100.

In another embodiment, the computer system 140 further comprises a non-volatile memory 150, for example, a read-only memory (ROM). The non-volatile memory 150 is coupled between the control module 130 and the input module 140 for storing the preset code generated by the input module 140. The input module 140 may be a keyboard, and the computer manager may input the preset code required to be set by the keyboard, for example, “12345”, so as to protect the power supply of the computer system 100.

In the following, the operation of the power supplier 100 is further described.

First, the computer system 100 is in the standby mode (for example, the idle mode or the pre-power-on mode). The control module 130 may detect whether there is a power-on request signal or a wake-up signal, that is, whether a user presses a power-on button to enable the computer system 100 to enter the working mode from the standby mode. If the control module 130 does not detect a power-on request signal or a wake-up signal, the control module 130 continues the detection. If the control module 130 detects a power-on request signal or a wake-up signal, it means that the computer system 100 will enter the working mode from the standby mode.

Here, the control module 130 provides a power request signal to the power supply module 120, and the power supply module 120 provides a power good signal to the control module 130 if the power supply module 120 is in a good state, so that the control module 130 may know that the power supply module 120 is already prepared to normally provide the working voltages. In addition, the control module 130 may receive the validation code and the preset code, and compare the validation code and the preset code. The preset code is, for example, preset by the system manager using the keyboard (for example, “12345”) or the dip switch (for example, “01010110”), and the validation code is input to the control module 130 by the user using a user interface.

If the validation code is in accordance with the preset code (for example, “12345” or “01010110”), the control module 130 may control the power supply module 120 to execute the power sequence control, i.e., sequentially generating a plurality of working voltages with different voltage levels to enable the computer system to enter the normal working mode.

In another aspect, if the validation code is not in accordance with the preset code (for example, “12345” or “01010110”), the control module 130, for example, generates a control signal to control the computer system 100 to be powered off or control the power supply module 120 to continue providing the standby voltages so that the computer system 100 is still in the standby mode. In this manner, the security for the power supply may be effectively improved.

In addition, if the validation code is not in accordance with the preset code, the control module 130, for example, generates an error signal and performs an accumulation on the occurrence times of the error signal. It is assumed that when the error signal is generated for the first time, the accumulated occurrence times of the error signal is 1, when the error signal is generated for the second time, the accumulated occurrence times of the error signal is 2, and so on. Next, the control module 130 may determine whether the accumulated occurrence times of the error signal exceeds a preset value, for example, 3.

If the accumulated occurrence times of the error signal exceed the preset value, the control module 130 generates the control signal to control the computer system 100 to be powered off or control the power supply module 120 to continue providing the standby voltages so that the computer system 100 is still in the standby mode.

In another aspect, if it is determined that the accumulated occurrence times of the error signal does not exceed the preset value, the control module 130 will again receive a new validation code. For example, the control module 130, for example, invites a user to input the new validation code by a user interface, and the user may input the new validation code upon receiving the invitation, so that the control module 130 can compare the validation code with the preset code.

If the validation code is in accordance with the preset code this time, the control module 130 controls the power supply module 120 to execute the power sequence management to provide the working voltages to the computer system 100 for its normal work. In addition, if the validation code is not in accordance with the preset code this time, the control module 130 continues generating the error signal and performs an accumulation on the occurrence times of the error signal until the accumulated occurrence times of the error signal exceeds the preset value, and then the control module 120 generates the control signal to control the computer system 100 to be powered off or control the power supply module 120 to continue providing the standby voltages so that the computer system 100 is still in the standby mode. In this manner, the security for the power supply may be effectively improved.

A power supply method of a power supplier can be concluded from the above embodiments. FIG. 2 is a flowchart of a power supply method of the power supplier according to the present disclosure. It is assumed that the computer system of this embodiment is in a standby mode (for example, an idle mode or a pre-power-on mode). In Step S210, when the computer system enters a working mode from the standby mode, a validation code is received. In Step S220, it is determined whether the validation code is in accordance with a preset code. In this embodiment, the preset code may be generated by a system manager using a dip switch or a keyboard, and the preset code may be stored in a non-volatile memory while the validation code is, for example, input by a user using a user interface.

If the validation code is in accordance with the preset code, the procedure proceeds to Step S230 to execute a power sequence control, so that the power supplier generates a plurality of working voltages required by the computer system. In the other hand, if the validation code is not in accordance with the preset code, the procedure proceeds to Step S240 to power off the computer system or keep the computer system in the standby mode.

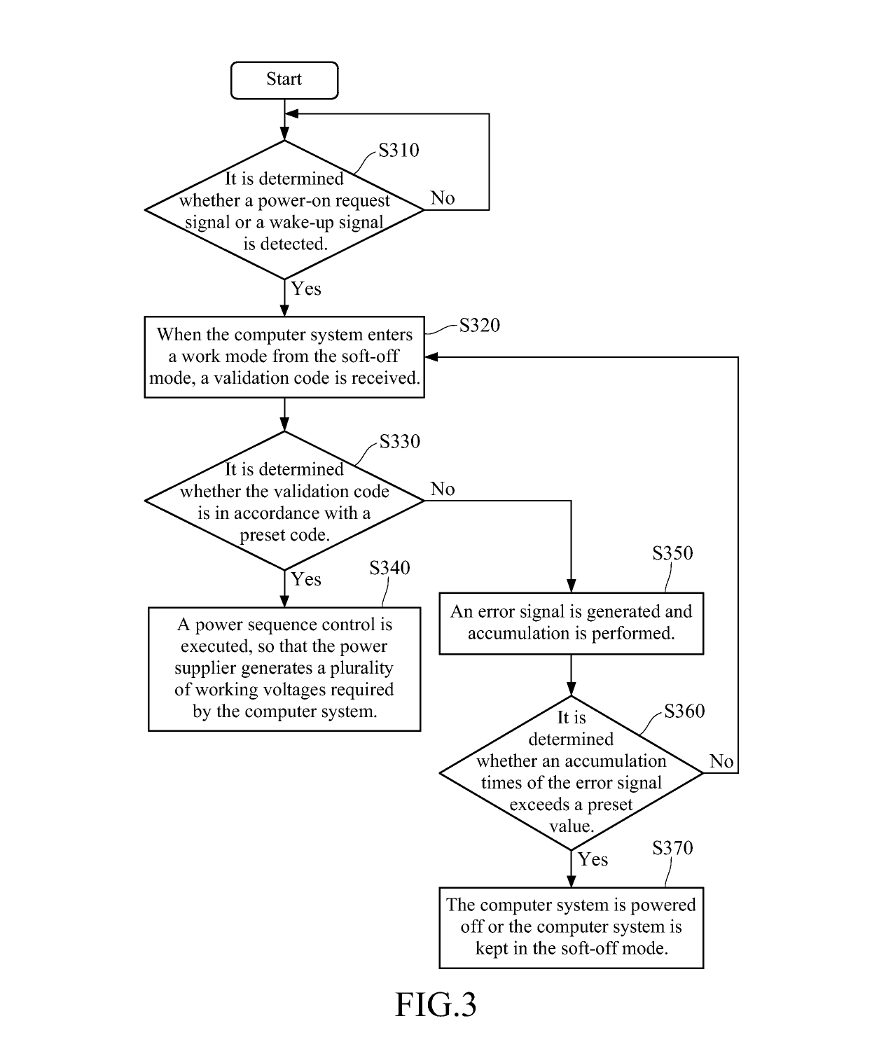

FIG. 3 is a flow-chart of a power supply method of a power supplier according to the present disclosure. Referring to FIG. 3, it is assumed that a computer system of this embodiment is in a standby mode (for example, an idle mode or a pre-power-on mode). In Step S310, it is determined whether a power-on request signal or a wake-up signal is detected. If a power-on request signal or a wake-up signal is not detected, the procedure returns to Step S310 to continuously perform the detection.

If a power-on request signal or a wake-up signal is detected, it means that the computer system will enter a working mode from the standby mode, and thus the procedure proceeds to Step S320 to receive a validation code which for example, is input by a user using a user interface. Then, in Step S330, it is determined whether the validation code is in accordance with a preset code. In this embodiment, the preset code may be, for example, generated by a system manager using a dip switch or a keyboard, and the preset code may be stored in a non-volatile memory.

If it is determined that the validation code is in accordance with the preset code, the procedure proceeds to Step S340 to execute a power sequence control, so that the power supplier generates a plurality of working voltages required by the computer system for its normal operation. If it is determined that the validation code is not accordance with the preset code, the procedure proceeds to Step S350 to generate an error signal and perform an accumulation on the occurrence times of the error signal.

Then, in Step S360, it is determined whether the accumulated occurrence times of the error signal exceeds a preset value. If it is determined that the accumulated occurrence times of the error signal exceeds the preset value, the procedure proceeds to Step S370 to power off the computer system or keep the computer system in the standby mode. In this manner, the security for the power supply of the computer system may be effectively improved.

In another aspect, if it is determined that the accumulated occurrence times of the error signal does not exceed the preset value, the procedure proceeds to Step S320 to receive a new validation code to perform Step S330 again to determine whether the validation code is in accordance with the preset code until the validation code is in accordance with the preset code, and thus the procedure proceeds to Step S340, or perform Step S330, S350, and S360 again to determine whether the accumulated occurrence times of the error signal exceeds the preset value until the accumulated occurrence times of the error signal exceeds the preset value, and thus the procedure proceeds to Step S370.

The power supplier of a computer system and the power supply method thereof according to the present disclosure compare whether a validation code is in accordance with a preset code when the computer system is to enter a working mode from a standby mode, so that the power supplier is controlled to provide a plurality of working voltages to the computer system to be powered on or enter the normal working mode, or the power supplier is controlled not to provide the working voltages, so that the computer system is powered off or the computer system is continuously kept in the standby mode. In this manner, the security for power supply of the power supplier may be effectively improved.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A power supply method of a power supplier, comprising:
receiving a validation code when a computer system enters a working mode from a standby mode;
determining whether the validation code is in accordance with a preset code;
if the validation code is in accordance with the preset code, executing a power sequence control, so that the power supplier generates a plurality of working voltages required by the computer system; and
if the validation code is not in accordance with the preset code, powering off the computer system or keeping the computer system in the standby mode.

2. The power supply method according to claim 1, wherein before the step of the computer system entering the wording mode from the standby mode, the method further comprises:
detecting a power-on request signal or a wake-up signal, so as to determine whether the computer system enters the working mode from the standby mode.

3. The power supply method according to claim 1, wherein before the step of powering off the computer system or keeping the computer system in the standby mode, the method further comprises:
if the validation code is not in accordance with the preset code, generating an error signal and performing an accumulation on the occurrence times of the error signal;
determining whether an accumulated occurrence times of the error signal exceeds a preset value;
if the accumulated occurrence times of the error signal exceeds the preset value, powering off the computer system or keeping the computer system in the standby mode; and
if the accumulated occurrence times of the error signal does not exceed the preset value, returning to the step of receiving the validation code.

4. The power supply method according to claim 1, wherein the preset code is generated by a dip switch or a keyboard.

5. The power supply method according to claim 4, wherein the preset code is stored in a non-volatile memory.

6. A power supplier of a computer system, comprising:
a power supply module for providing a plurality of standby voltages and a plurality of working voltages; and
a control module coupled to the power supply module for receiving a validation code and a preset code, based on which to determine whether to control the power supply module to execute a power sequence control according to the validation code and the preset code to convert the standby voltages to the working voltages,
wherein when the computer system enters a working mode from a standby mode and the control module determines that the validation code is in accordance with the preset code, the control module controls the power supply module to execute the power sequence control, so that the power supply module provides the working voltages to the computer system, and when the computer system enters the working mode from the standby mode and the control module determines that the validation code is not in accordance with the preset code, the control module controls the power supply mode not to provide the working voltages to the computer system or to continue providing the standby voltages to the computer system.

7. The power supplier of the computer system according to claim 6, wherein the control module further detects a power-on request signal or a wake-up signal to determine whether the computer system enters the working mode from the standby mode.

8. The power supplier of the computer system according to claim 6, wherein when the validation code is not in accordance with the preset code, the control module generates an error signal and performs an accumulation on the occurrence times of the error signal, the control module determines whether an accumulated occurrence times of the error signal exceeds a preset value, if the accumulated occurrence times of the error signal exceeds the preset value, the control module controls the power supply module not to provide the working voltages to the computer system or to continue providing the standby voltages to the computer system, and if the accumulated occurrence times of the error signal does not exceed the preset value, the control module compares the validation code and the preset code again until the accumulated occurrence times of the error signal exceeds the preset value.

9. The power supplier of the computer system according to claim 6, wherein the computer system comprises an input module coupled to the control module for generating the validation code.

10. The power supplier of the computer system according to claim 9, wherein the computer system comprises a non-volatile memory coupled between the control module and the input module for storing the preset code.
